(19) United States
(12) Patent Application Publication
(10) Pub. No.: US 2024/0378889 A1
(43) Pub. Date: Nov. 14, 2024

(54) Devices and Methods for Computer Vision Guided Monitoring and Analysis of a Display Module

(71) Applicant: ZEBRA TECHNOLOGIES CORPORATION, Lincolnshire, IL (US)

(72) Inventors: Ankit Kumar, Essex (GB); Eunhyang Kim, London (GB); Francesco Lupo, London (GB); Chih Huan Chien, Buffalo Grove, IL (US); Samadhi Poornima Kumarasinghe Wickrama Arachchilage, London (GB); Lingchao Kong, Lake Zurich, IL (US); Zachery P. Berg, Indianapolis, IN (US)

(21) Appl. No.: 18/195,647

(22) Filed: May 10, 2023

(51) Int. Cl. G06V 20/50; G06T 7/00; G06V 10/82

(52) U.S. Cl. CPC G06V 20/50; G06T 7/0002; G06V 10/82; G06T 2207/20084; G06T 2207/20212; H04N 5/2624

(57) ABSTRACT

Devices and methods for computer vision guided monitoring and analysis of a display module are disclosed herein. The method receives at least one captured image of at least a portion of an object for displaying at least one item. The method quantifies a state of the object present in the captured image by determining at least one anomaly associated with the object present in the captured image based on a comparison of at least one extracted attribute of the object present in the captured image and at least one extracted attribute of the object present in a reference image where the reference image is indicative of an optimal state of the object present in the captured image. The method determines whether the anomaly is greater than a threshold and generates and transmits a notification when the anomaly is greater than the threshold.

### BACKGROUND

A facility (e.g., a retail facility such as a grocery store, convenience store, big box store, etc.) can include at least one support structure (e.g., a display module) with one or more support surfaces (e.g., shelves) for carrying and displaying one or more items. An associate of a facility can utilize a planogram to determine a location of each type of item in the facility and arrange each type of item on a display module to provide for an organized appearance of items carried and displayed thereon. For example, items can be faced on a display module such that the items are positioned on a front edge of a support surface of the display module and oriented to be identifiable (e.g., an item identifier such as a name, logo and/or slogan is observable by a customer and/or an item is associated and aligned with a label of a support surface such as a Stock Keeping Unit (SKU) or a product code). An organized and planogram compliant display module is appealing to a customer because it provides for an organized facility and facilitates locating items of interest which improve an experience of the customer.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating an embodiment of a system of the present disclosure.

FIG. 2 is a diagram illustrating components of the computing device of FIG. 1.

FIG. 3A is a flowchart illustrating processing steps carried out by an embodiment of the present disclosure for registering a reference image.

FIG. 3B is a flowchart illustrating processing steps carried out by an embodiment of the present disclosure for quantifying a state of an object present in a processed image.

FIG. 4 is a flowchart illustrating step 304 of FIG. 3A and step 314 of FIG. 3B in greater detail.

FIG. 5 is a diagram illustrating step 334 of FIG. 4.

FIG. 6 is a diagram illustrating step 336 of FIG. 4.

FIG. 7A is a diagram illustrating step 306 of FIG. 3A.

FIG. 7B is a diagram illustrating step 316 of FIG. 3B.

FIG. 8 illustrates a reference image of an embodiment of the present disclosure.

FIGS. 9A-B are diagrams illustrating a comparison of a processed image and a reference image for determining an anomaly carried out by an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As mentioned above, an organized and planogram compliant display module is appealing to a customer because it provides for an organized facility and facilitates locating items of interest which improve an experience of the customer. By interfacing with customers, a display module can become unorganized and/or depleted (e.g., an item becomes out of stock) which can result in lost sales because customers cannot locate items of interest. Conventional monitoring and/or analysis systems can be manual (e.g., rely on human intervention) and, as such, can be time-consuming, cost-prohibitive (e.g., increased associate labor costs), and subject to human error (e.g., quantifying a state of a display module).

For example, it can be time-consuming to manually monitor and analyze each display module of a facility to determine whether each display module requires re-organizing and/or re-stocking. As such, facility labor costs can increase via additional labor hours (e.g., overtime) required to execute tasks associated with, but not limited to, customer service, buy online pickup in store (BOPIS) orders, inventory, and training that otherwise would have been executed if not for labor hours utilized manually monitoring and analyzing each display module of a facility. It can also be challenging for an associate to quantify a state (e.g., a degree of unorganization) of a display module. For example, an acceptable state of a display module can depend on a threshold. The threshold can be set based on several variables that can impact a state of the display module including, but not limited to, a season (e.g., Spring and Summer), a sale (e.g., President's Day and Memorial Day), a holiday (e.g., Fourth of July and Thanksgiving), an event (e.g., Halloween and back to school), a facility, an item category, an item type and/or any combination thereof.

Additionally, these systems can require imaging systems (e.g., high-resolution camera systems) that are cost-prohibitive to deploy and utilize in a facility. These systems also cannot automatically notify an associate in real-time of an unorganized and/or depleted state of a display module. This can result in lost sales because customers cannot locate items of interest and/or can result in facility liability due to an onsite injury (e.g., a head injury from an item falling from a display module and/or a slip and fall injury from an item on a floor proximate to the display module).

As such, conventional systems suffer from a general lack of versatility because these systems cannot automatically and dynamically quantify a state of a display module based on a captured and processed image of at least a portion of a display module, a reference image associated with the display module present in the processed image, and a set threshold based on several variables that can impact a state of the display module.

Overall, this lack of versatility causes conventional systems to provide underwhelming performance and reduce the efficiency and general timeliness of executing facility tasks. Thus, it is an objective of the present disclosure to eliminate these and other problems with conventional systems and methods via systems and methods that can automatically and dynamically quantify a state of an object present in a processed image by determining at least one anomaly associated with the object present in the processed image based on a comparison of at least one extracted attribute of the object present in the processed image and at least one extracted attribute of the object present in a reference image; determine whether the at least one anomaly is greater than a threshold; and generate and transmit a notification when the at least one anomaly is greater than the threshold where the at least one anomaly is indicative of at least one deficiency associated with the object present in the processed image.

In accordance with the above, and with the disclosure herein, the present disclosure includes improvements in computer functionality or in improvements to other technologies at least because the present disclosure describes that, e.g., information systems, and their related various components, may be improved or enhanced with the disclosed dynamic system features and methods that provide more efficient workflows for workers and improved monitoring and management of display modules and planograms thereof for system administrators. That is, the present disclosure describes improvements in the functioning of an information system itself or “any other technology or technical field” (e.g., the field of distributed and/or commercial information systems). For example, the disclosed dynamic system features and methods improve and enhance the quantification of a state of an object present in a processed image by determining at least one anomaly associated with the object present in the processed image based on a comparison of at least one extracted attribute of the object present in the processed image and at least one extracted attribute of the object present in a reference image to mitigate (if not eliminate) worker error and eliminate inefficiencies typically experienced over time by systems lacking such features and methods. This improves the state of the art at least because such previous systems are inefficient as they lack the ability to automatically and dynamically determine whether at least one anomaly associated with an object present in a processed image is greater than a threshold where the threshold can be set based on several variables that can impact a state of the object and generate and transmit a notification in real-time when the at least one anomaly is greater than the threshold where the at least one anomaly is indicative of at least one deficiency associated with the object present in the processed image.

In addition, the present disclosure applies various features and functionality, as described herein, with, or by use of, a particular machine, e.g., a processor, a mobile device (e.g., a phone, a tablet, a mobile computer, wearable or camera) and/or other hardware components as described herein. Moreover, the present disclosure includes specific features other than what is well-understood, routine, conventional activity in the field, or adds unconventional steps that demonstrate, in various embodiments, particular useful applications, e.g., quantifying a state of an object present in a processed image by determining at least one anomaly associated with the object present in the processed image based on a comparison of at least one extracted attribute of the object present in the processed image and at least one extracted attribute of the object present in a reference image in connection with providing an organized and planogram compliant display module.

Accordingly, it would be highly beneficial to develop a system and method that can automatically and dynamically quantify a state of an object present in a processed image by determining at least one anomaly associated with the object present in the processed image based on a comparison of at least one extracted attribute of the object present in the processed image and at least one extracted attribute of the object present in a reference image; determine whether the at least one anomaly is greater than a threshold; and generate and transmit a notification when the at least one anomaly is greater than the threshold where the at least one anomaly is indicative of at least one deficiency associated with the object present in the processed image. The devices and methods of the present disclosure address these and other needs.

In an embodiment, the present disclosure is directed to a method. The method comprises: receiving at least one captured image of at least a portion of an object, the object being a display module for displaying at least one item; quantifying a state of the object present in the at least one captured image by determining at least one anomaly associated with the object present in the at least one captured image based on a comparison of at least one extracted attribute of the object present in the at least one captured image and at least one extracted attribute of the object present in a reference image, the reference image being indicative of an optimal state of the object present in the at least one captured image; determining whether the at least one anomaly is greater than a threshold; and generating and transmitting a notification when the at least one anomaly is greater than the threshold where the at least one anomaly is indicative of at least one deficiency associated with the object present in the at least one captured image.

In an embodiment, the present disclosure is directed to another method. The method comprises: capturing at least one image of at least a portion of an object, the object being a display module for displaying at least one item; processing the at least one captured image; extracting at least one attribute of the object present in the processed image; obtaining at least one extracted attribute of the object present in a reference image, the reference image being indicative of an optimal state of the object present in the processed image; quantifying a state of the object present in the processed image by determining at least one anomaly associated with the object present in the processed image based on a comparison of the at least one extracted attribute of the object present in the processed image and the at least one extracted attribute of the object present in the reference image; determining whether the at least one anomaly is greater than a threshold; and generating and transmitting a notification when the at least one anomaly is greater than the threshold where the at least one anomaly is indicative of at least one deficiency associated with the object present in the processed image.

In an embodiment, the present disclosure is directed to a device comprising an imaging assembly configured to capture at least one image of at least a portion of an object where the object is a display module for displaying at least one item; one or more processors; and a non-transitory computer-readable memory coupled to the imaging assembly and the one or more processors. The memory stores instructions thereon that, when executed by the one or more processors, cause the one or more processors to: process the at least one captured image; extract at least one attribute of the object present in the processed image; obtain at least one extracted attribute of the object present in a reference image, the reference image being indicative of an optimal state of the object present in the processed image; quantify a state of the object present in the processed image by determining at least one anomaly associated with the object present in the processed image based on a comparison of the at least one extracted attribute of the object present in the processed image and the at least one extracted attribute of the object present in the reference image; determine whether the at least one anomaly is greater than a threshold; and generate and transmit a notification when the at least one anomaly is greater than the threshold where the at least one anomaly is indicative of at least one deficiency associated with the object present in the processed image.

In an embodiment, the present disclosure is directed to a system. The system comprises at least one device having an imaging assembly configured to capture at least one image of at least a portion of an object where the object is a display module for displaying at least one item; a server having one or more processors; and a non-transitory computer-readable memory coupled to the server and the one or more processors. The memory stores instructions thereon that, when executed by the one or more processors, cause the one or more processors to: process the at least one captured image; extract at least one attribute of the object present in the processed image; obtain at least one extracted attribute of the object present in a reference image, the reference image being indicative of an optimal state of the object present in the processed image; quantify a state of the object present in the processed image by determining at least one anomaly associated with the object present in the processed image based on a comparison of the at least one extracted attribute of the object present in the processed image and the at least one extracted attribute of the object present in the reference image; determine whether the at least one anomaly is greater than a threshold; and generate and transmit a notification when the at least one anomaly is greater than the threshold where the at least one anomaly is indicative of at least one deficiency associated with the object present in the processed image.

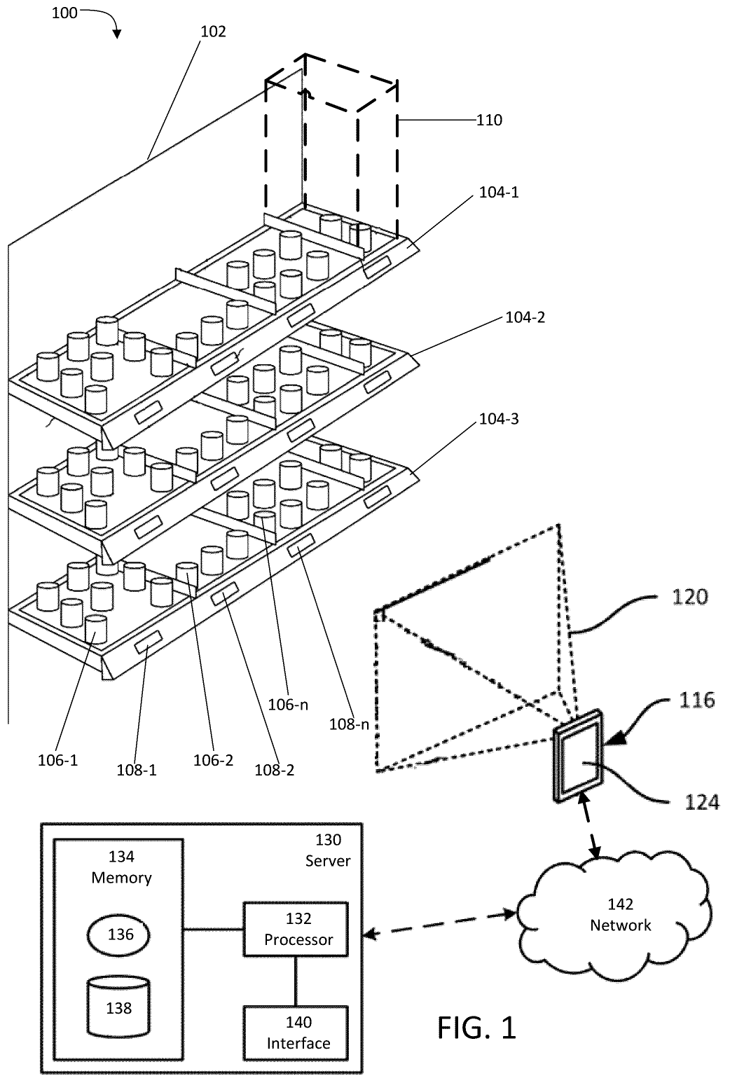

Turning to the Drawings, FIG. 1 is a diagram 100 illustrating an embodiment of a system of the present disclosure. FIG. 1 illustrates a system for dynamic display module monitoring and analysis. The system can be deployed in a facility (e.g., a grocery store, convenience store, big box store, etc.). For example, the system can be deployed in a customer-accessible portion of the facility that may be referred to as the front of the facility.

Items received at the facility, e.g. via a receiving bay or the like, are generally placed on a support structure (e.g., a display module) with one or more support surfaces (e.g., shelves) in a stock room, until restocking of the relevant items is required in the front of the facility. An associate can retrieve the items requiring restocking from the back room, and transport those items to the appropriate locations in the front of the facility. Locations for items in the front of the facility are typically predetermined, e.g. according to a planogram that specifies, for each portion of shelving or other support structures, which items are to be placed on such structures. The planogram can be accessed from a mobile device operated by the associate, kept on a printed sheet or the like.

As mentioned above, an organized and planogram compliant display module is appealing to a customer because it provides for an organized facility and facilitates locating items of interest which improve an experience of the customer. By interfacing with customers, a display module can become unorganized and/or depleted (e.g., an item becomes out of stock) which can result in lost sales because customers cannot locate items of interest. Conventional monitoring and/or analysis systems can be manual (e.g., rely on human intervention) and, as such, can be time-consuming, cost-prohibitive (e.g., increased associate labor costs), and subject to human error (e.g., quantifying a state of a display module). For example, it can be time and cost prohibitive to manually monitor and analyze each display module of a facility to determine whether each display module requires re-organizing and/or re-stocking which can include facing. The system provides for automatically and dynamically quantifying a state of an object present in a processed image by determining at least one anomaly associated with the object present in the processed image based on a comparison of at least one extracted attribute of the object present in the processed image and at least one extracted attribute of the object present in a reference image; determining whether the at least one anomaly is greater than a threshold; and generating and transmitting a notification when the at least one anomaly is greater than the threshold where the at least one anomaly is indicative of at least one deficiency associated with the object present in the processed image.

As shown in FIG. 1, the facility includes at least one support structure such as a display module 102 with one or more support surfaces 104-1, 104-2, and 104-3 (collectively referred to as support surfaces 104, and generically referred to as support surface 104) carrying and displaying items 106-1, 106-2, and 106-n (collectively referred to as items 106, and generically referred to as item 106). The items 106 may be of different types such that item 106-1 is different from items 106-2 and 106-n, item 106-2 is different from item 106-n, etc. In addition, an item 106 can comprise one or more items. For example, item 106-1 comprises a group of eight items 106-1 and item 106-2 comprises a group of three items 106-2. Items 106-1, 106-2 and 106-3 can be respectively identified by item labels 108-1, 108-2 and 108-n (collectively referred to as labels 108, and generically referred to as label 108). For example, the label 108 can be a SKU and/or product code (e.g. a Universal Product Code (UPC)) or the like. A planogram can specify an item area 110 (e.g., of a support surface 104) indicative of a position of an item 106. An item area 110 can be determined relative to an alignment of a label 108 (e.g., left, right or center-aligned). As described in further detail below, re-organizing and/or restocking a display module 102 can include facing items 106 on the display module such that the items 106 are positioned on a front edge of a support surface 104 and oriented to be identifiable (e.g., an item identifier such as a name, logo and/or slogan is observable by a customer and/or an item 106 is associated and aligned with a label 108).

The system can include a device 116, such as a smart phone, a tablet computer, a mobile computer, a wearable or the like. The device 116 can be operated by an associate at the facility, and includes an imaging assembly (e.g., a camera) having a field of view (FOV) 120 and a display 124. Alternatively, the device 116 can be an imaging assembly (e.g., a camera). For example, the device 116 can be a camera mounted on a first display module 102 and having a FOV 120 of at least a portion of a second display module 102 positioned across therefrom. In another example, the device 116 can be a camera fixed in an overhead position above a display module 102 and having a FOV 120 of at least a portion of a display module 102 positioned beneath the device 116. The device 116 can be manipulated such that the imaging assembly can view at least a portion of the display module 102 within the FOV 120 and can be configured to capture an image or a stream of images of the display module 102. From such images, the device 116 can detect and extract at least one attribute (e.g., a feature) of the display module 102 such as a shape, a color, a pattern, a logo, a size, a width, a length, a height, and an item displayed by the display module 102.

Certain components of a server 130 are also illustrated in FIG. 1. The server 130 can include a processor 132 (e.g. one or more central processing units (CPUs)), interconnected with a non-transitory computer readable storage medium, such as a memory 134 and an interface 140. The memory 134 includes a combination of volatile memory (e.g. Random Access Memory or RAM) and non-volatile memory (e.g. read only memory or ROM, Electrically Erasable Programmable Read Only Memory or EEPROM, flash memory). The processor 132 and the memory 134 each comprise one or more integrated circuits.

The memory 134 stores computer readable instructions for execution by the processor 132. The memory 134 stores a monitoring and analysis application 136 (also referred to simply as the application 136) which, when executed by the processor 132, configures the processor 132 to perform various functions described below in greater detail and related to automatically and dynamically quantifying a state of an object present in a processed image by determining at least one anomaly associated with the object present in the processed image based on a comparison of at least one extracted attribute of the object present in the processed image and at least one extracted attribute of the object present in a reference image; determining whether the at least one anomaly is greater than a threshold; and generating and transmitting a notification when the at least one anomaly is greater than the threshold where the at least one anomaly is indicative of at least one deficiency associated with the object present in the processed image. As described below, this functionality can also be executed by the processor 202 of the device 116.

The application 136 may also be implemented as a suite of distinct applications in other examples. Those skilled in the art will appreciate that the functionality implemented by the processor 132 via the execution of the application 136 may also be implemented by one or more specially designed hardware and firmware components, such as field-programmable gate arrays (FPGAs), application-specific integrated circuits (ASICs) and the like in other embodiments. The memory 134 also stores a repository 138 including one or more image datasets of a plurality of display modules 102 and items 106 thereof.

The server 130 also includes a communications interface 140 enabling the server 130 to communicate with other computing devices, including the device 116, via the network 142. The communications interface 140 includes suitable hardware elements (e.g. transceivers, ports and the like) and corresponding firmware according to the communications technology employed by the network 142.

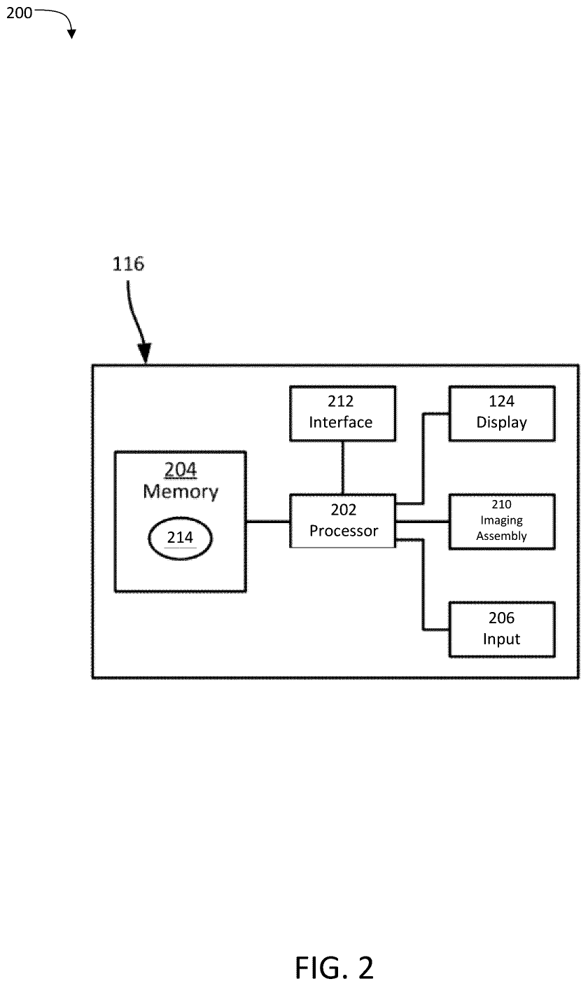

FIG. 2 is a diagram 200 illustrating components of the device 116 of FIG. 1. The device 116 includes a processor 202 (e.g. one or more CPUs), interconnected with a non-transitory computer readable storage medium, such as a memory 204, an input 206, a display 124, an imaging assembly 210, and an interface 212. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 202 and the memory 204 each comprise one or more integrated circuits.

The at least one input 206 can be a device interconnected with the processor 202. The input device 206 is configured to receive an input (e.g. from an operator of the device 116) and provide data representative of the received input to the processor 202. The input device 206 can include any one of, or a suitable combination of, a touch screen integrated with the display 124, a keypad, a microphone, a barcode scanner and the like. For example, an operator can utilize the barcode scanner to scan a label 108.

The imaging assembly 210 (e.g., a camera) includes a suitable image sensor or combination of image sensors. As mentioned above, the device 116 can be an imaging assembly (e.g., a camera). For example, the device 116 can be a camera mounted on a first display module 102 and having a FOV 120 of at least a portion of a second display module 102 positioned across therefrom. In another example, the device 116 can be a camera fixed in an overhead position above a display module 102 and having a FOV 120 of at least a portion of a display module 102 positioned beneath the device 116. The camera 210 is configured to capture one or more images for provision to the processor 202 and subsequent processing to detect and extract at least one attribute (e.g., a feature) of the display module 102 such as a shape, a color, a pattern, a logo, a size, a width, a length, a height, and an item displayed by the display module 102. As such, the camera 210 of the device 116 or the device 116 need not be a high-resolution camera or a system of high-resolution cameras to decode a label 108 from a captured image because the processor 202 can quantify a state of a display module 102 based on a captured image of the display module 102, a reference image of the display module 102 and a set threshold based on several variables that can impact a state of the display module 102.

In addition to the display 124, the device 116 can also include one or more other output devices, such as a speaker, a notification light-emitting diode (LED), and the like (not shown). The communications interface 212 enables the device 116 to communicate with other computing devices, such as the server 130, via the network 142. The interface 212 therefore includes a suitable combination of hardware elements (e.g. transceivers, antenna elements and the like) and accompanying firmware to enable such communication.

The memory 204 stores computer readable instructions for execution by the processor 202. In particular, the memory 204 stores a monitoring and analysis application 214 (also referred to simply as the application 214) which, when executed by the processor 202, configures the processor 202 to perform various functions discussed below in greater detail and related to automatically and dynamically quantifying a state of an object present in a captured and processed image by determining at least one anomaly associated with the object present in the processed image based on a comparison of at least one extracted attribute of the object present in the processed image and at least one extracted attribute of the object present in a reference image; determining whether the at least one anomaly is greater than a threshold; and generating and transmitting a notification when the at least one anomaly is greater than the threshold where the at least one anomaly is indicative of at least one deficiency associated with the object present in the processed image. The application 214 may also be implemented as a suite of distinct applications in other examples. Those skilled in the art will appreciate that the functionality implemented by the processor 202 via the execution of the application 214 may also be implemented by one or more specially designed hardware and firmware components, such as FPGAs, ASICs and the like in other embodiments. As noted above, in some examples the memory 204 can also store the repository 138, rather than the repository 138 being stored at the server 130.

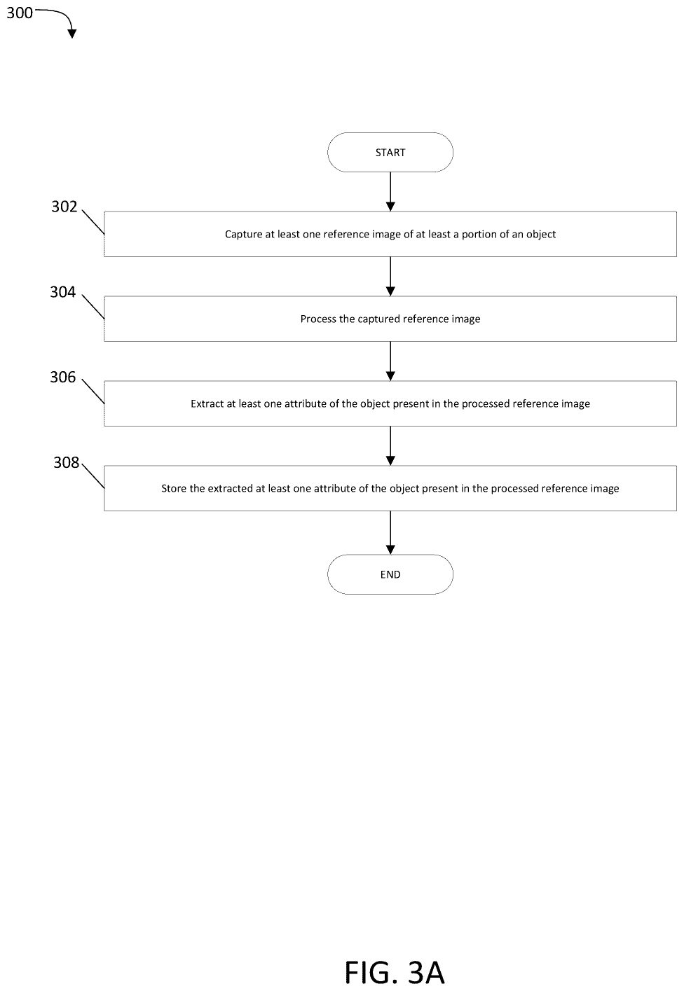

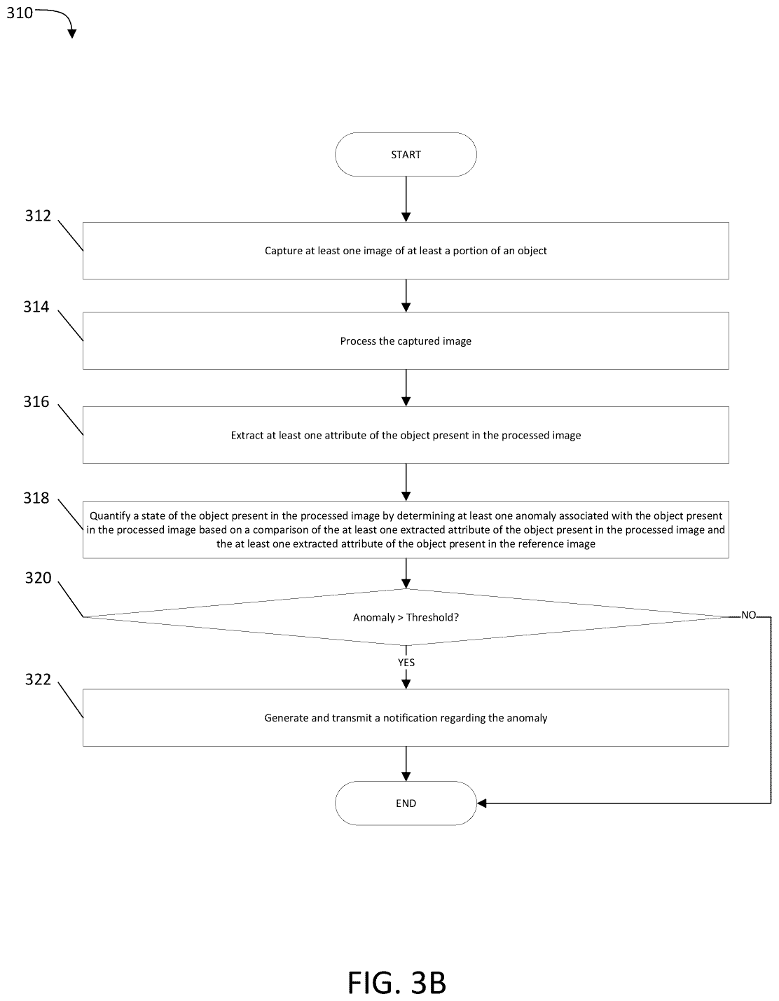

FIG. 3A is a flowchart 300 illustrating processing steps carried out by an embodiment of the present disclosure for registering a reference image and FIG. 3B is a flowchart 310 illustrating processing steps carried out by an embodiment of the present disclosure for quantifying a state of an object present in a processed image.

The processing steps will be described in conjunction with their performance in the system (e.g., by the device 116 or the server 130 in conjunction with the device 116). In general, via performance of the processing steps, the system can automatically and dynamically quantify a state of a display module 102. For example, the system can automatically and dynamically quantify a state of an object present in a processed image by determining at least one anomaly associated with the object present in the processed image based on a comparison of at least one extracted attribute of the object present in the processed image and at least one extracted attribute of the object present in a reference image; determine whether the at least one anomaly is greater than a threshold; and generate and transmit a notification when the at least one anomaly is greater than the threshold where the at least one anomaly is indicative of at least one deficiency associated with the object present in the processed image.

Referring to FIG. 3A, in step 302, the system captures at least one reference image of an object (e.g., a display module 102). For example, the system can capture an image via the camera 210 of the device 116 by manipulating the camera 210 such that a FOV of the camera 210 includes at least a portion of the display module 102 including at least one item 106 and at least one label 108. The system can automatically capture a reference image when a display module 102 is likely to be organized and/or re-stocked (e.g., when a display module 102 does not interface with customers).

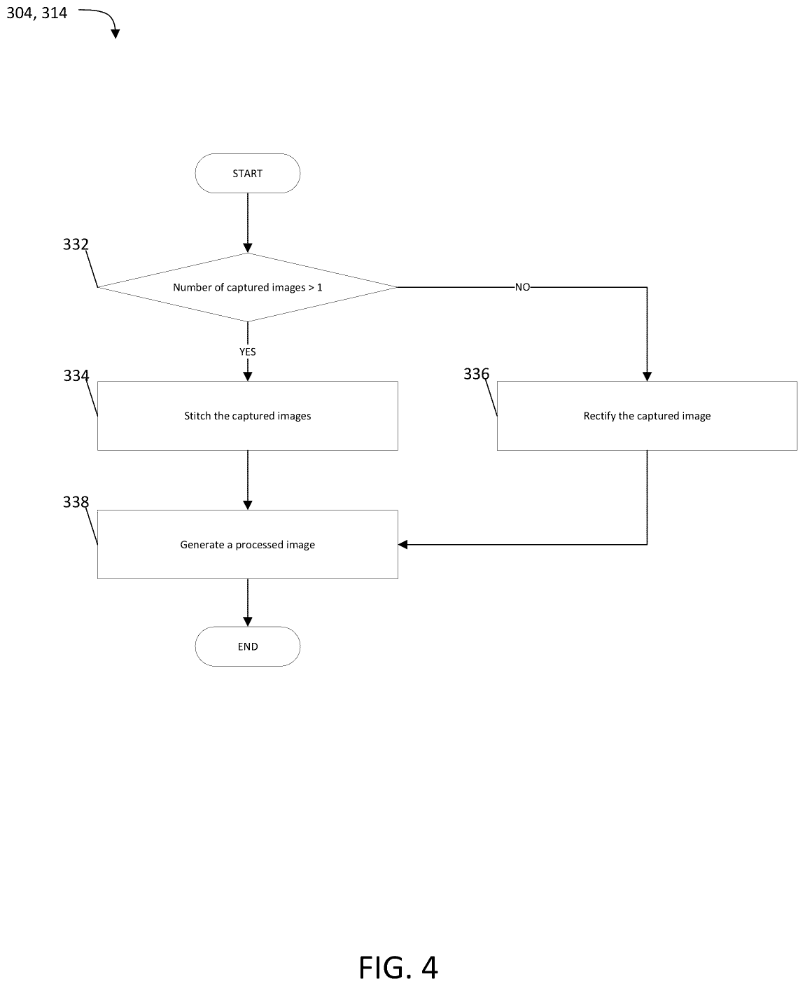

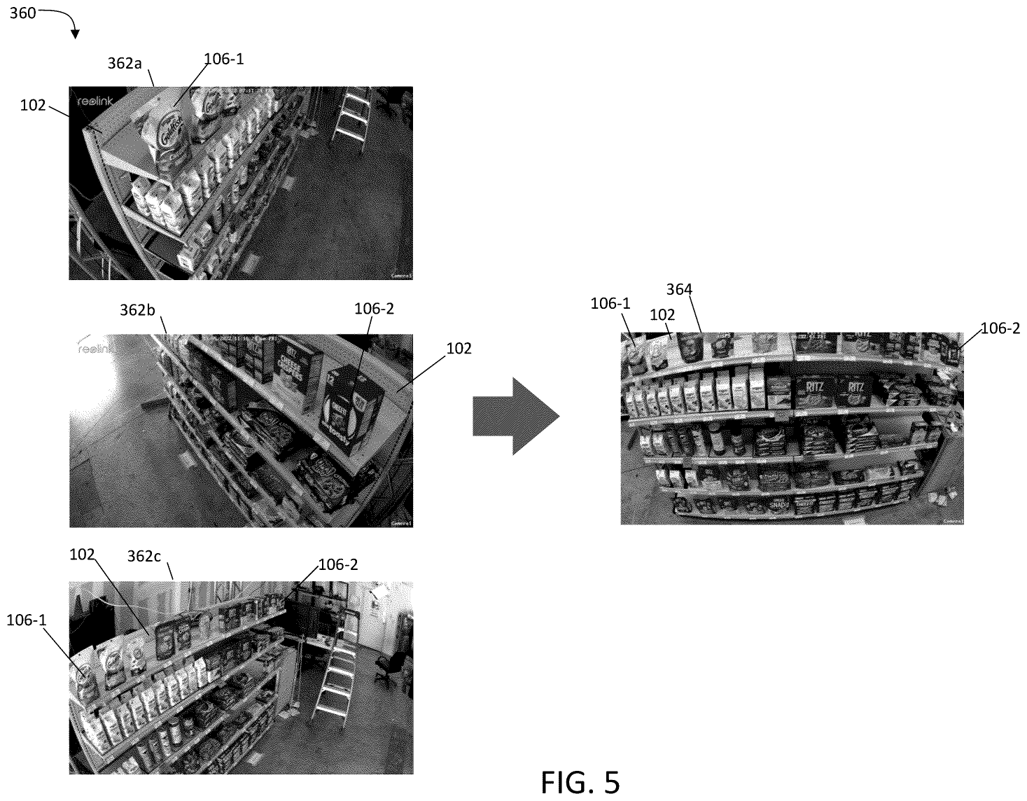

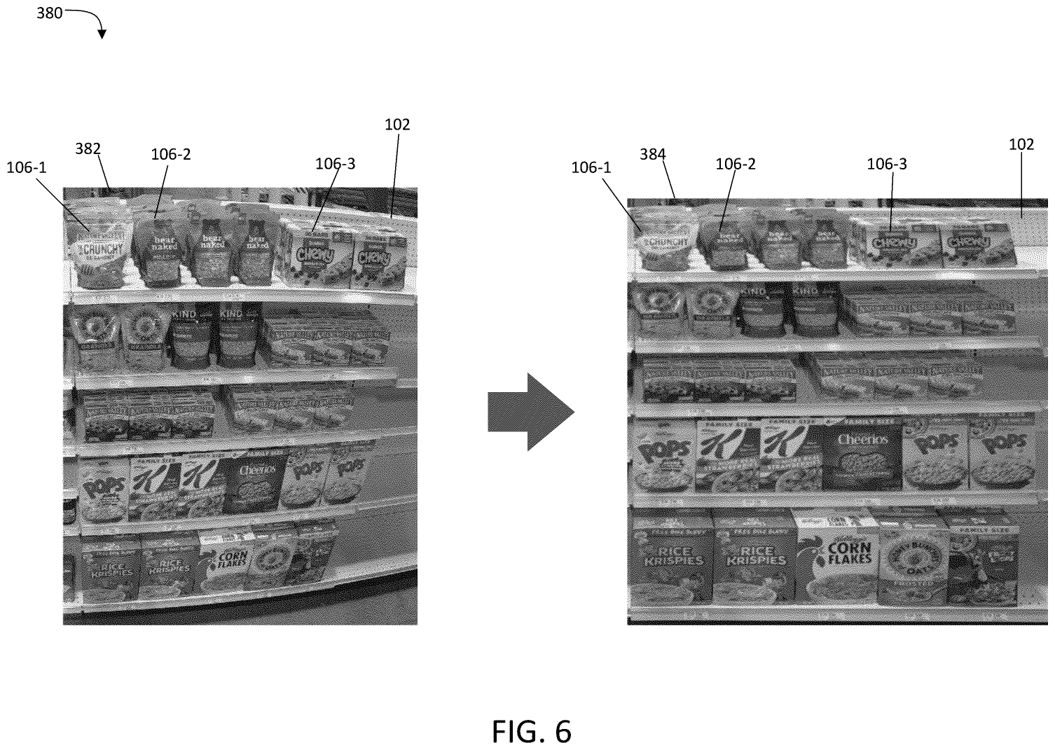

In step 304, the system processes the captured referenced image. FIG. 4 is a flowchart illustrating step 304 of FIG. 3A in greater detail and FIGS. 5 and 6 are diagrams respectively illustrating image processing. The processing steps of FIG. 4 can be utilized to process a captured image (e.g., a reference image and/or a general image). Referring to FIG. 4, in step 332 the system determines whether a number of captured images is greater than 1. If the system determines that a number of captured images is greater than 1, then the process proceeds to step 334. In step 334, the system stitches the captured images together. Then, in step 338, the system generates a processed image 338 (e.g., a composite image). Generally, a facility employing frictionless checkout can utilize several overhead devices 116 (e.g., cameras) and these devices 116 can capture images of at least a portion of a display module 102 from different angles. As such, these images are stitched together to generate a processed image (e.g., a composite image) of a display module 102. FIG. 5 is a diagram 360 illustrating step 334 of FIG. 4 for image stitching. As shown in FIG. 5, images 362a, 362b and 362c illustrate a display module 102 carrying and displaying items 106-1 and 106-2 and are stitched together to generate a processed image 364 of the display module 102 and items 106-1 and 106-2 carried and displayed thereon.

Returning to FIG. 4, if the system determines that a number of captured images is not greater than 1, then the process proceeds to step 336. In step 336, the system rectifies the captured image to reduce image distortion. Then, in step 338, the system generates a processed image 338 (e.g., a rectified image). A facility can employ a device 116 (e.g., a smart phone, a tablet, a mobile computer, or a wearable) and this device 116 can capture an image of at least a portion of a display module 102 from a wide angle resulting in image distortion. Additionally or alternatively, a facility can employ a device 116 (e.g., a camera) mounted on a display module 102 and this device 116 can capture an image of at least a portion of another display module 102 positioned across therefrom from a wide angle resulting in image distortion. As such, this image is rectified to reduce image distortion and to generate a processed (e.g., rectified) image of a display module 102. FIG. 6 is a diagram 380 illustrating step 336 of FIG. 4 for image rectification. As shown in FIG. 6, image 382 of a display module 102 carrying and displaying items 106-1, 106-2, and 106-3 is rectified to generate a processed image 384 of the display module 102 and items 106-1, 106-2, and 106-3 carried and displayed thereon.

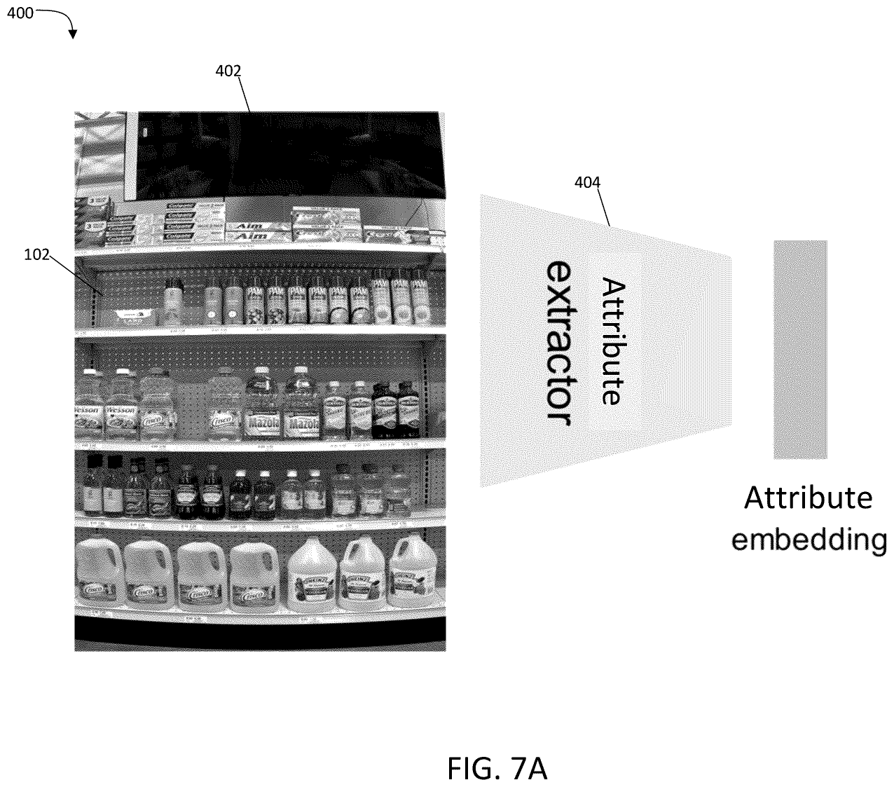

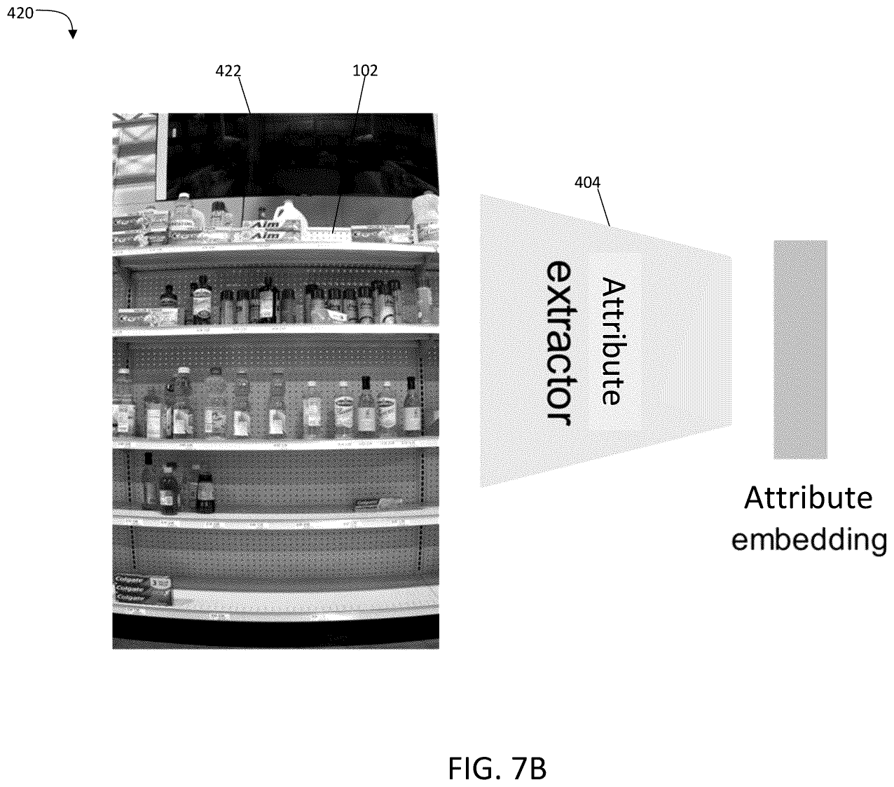

Returning to FIG. 3A, in step 306 the system extracts at least one attribute of the object (e.g., a display module 102) present in the processed reference image. For example, the system can extract at least one attribute of a display module 102 including, but not limited to, a shape, color, pattern, logo, size, width, length, height, and item 106 of the display module 102 by utilizing a neural network (e.g., a convolutional neural network (CNN)) to convert the processed image into a set of floating numbers or vectors indicative of at least one attribute of the display module 102. In this way, the system can extract at least one global attribute of the display module 102. Alternatively, the system can extract a plurality of regional attributes of the display module 102 by applying matrices over different portions of the processed image. FIG. 7A is a diagram 400 illustrating step 306 of FIG. 3A. As shown in FIG. 7A, the system utilizes an attribute extractor 404 (e.g., a CNN) to covert the processed reference image 402 into a set of floating number or vectors indicative of at least one attribute of the display module 102 present in the processed reference image 422.

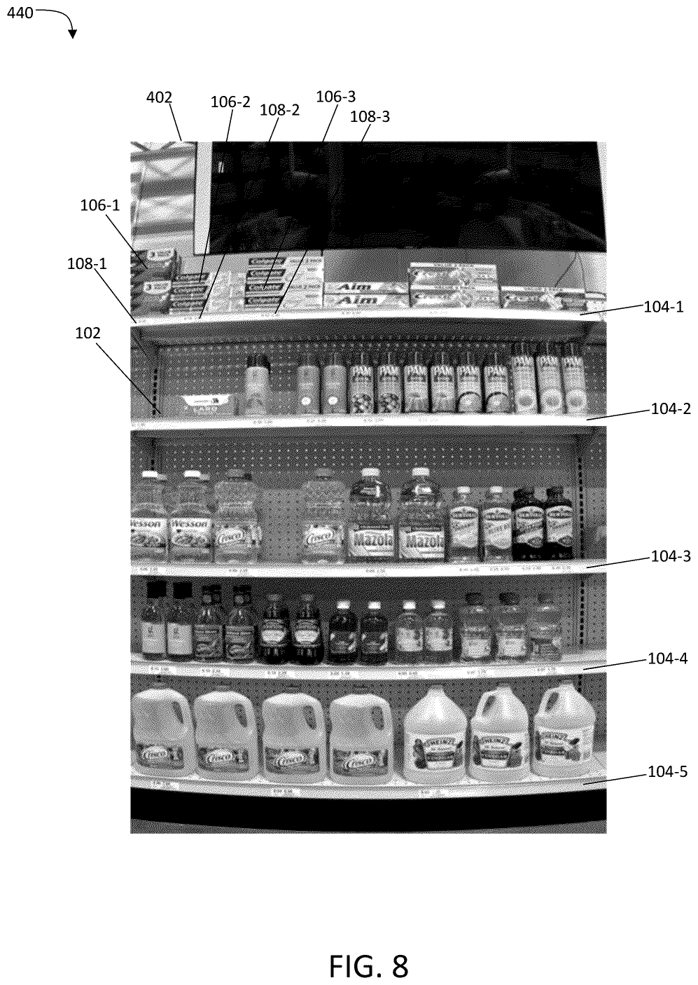

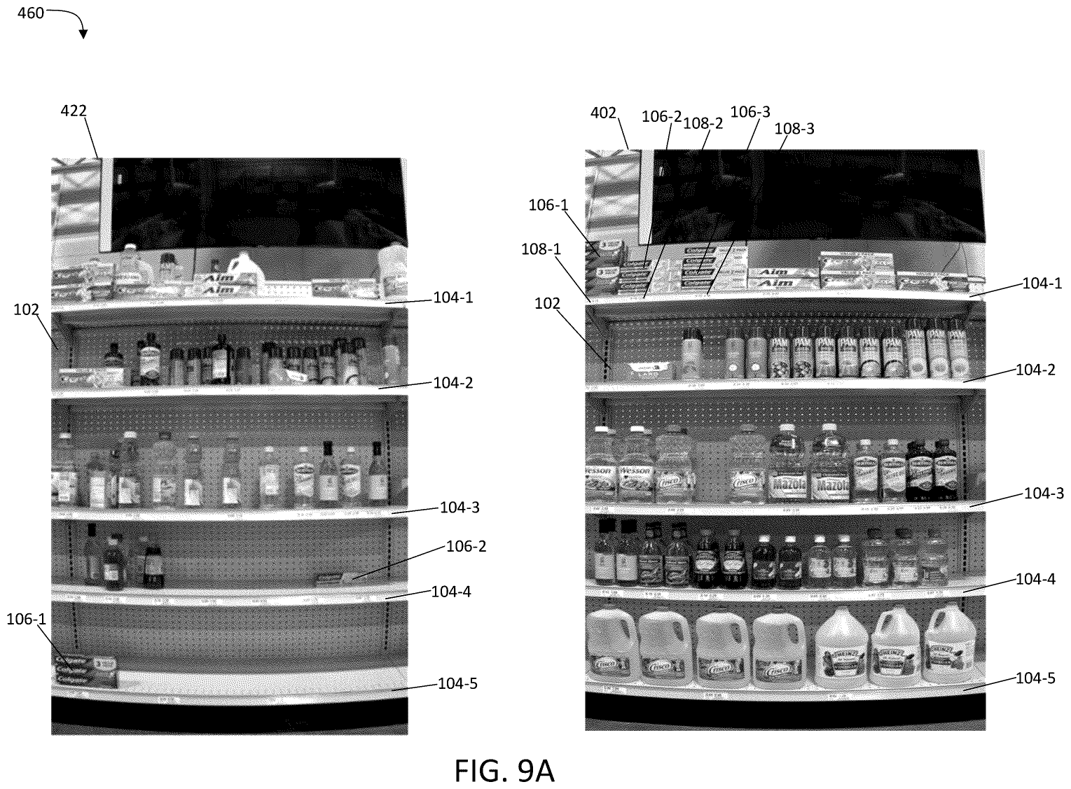

Returning to FIG. 3A, in step 308 the system stores the extracted at least one attribute of the object (e.g., a display module 102) present in the processed reference image. The system can additionally store the reference image. A reference image is indicative of an optimal state of an object present in a processed image (e.g., a general image). FIG. 8 illustrates a reference image 402 of an embodiment of the present disclosure. As shown in FIG. 8, the reference image 402 depicts an organized display module 102 where items 106 are faced on the display module 102 such that the items 106 are positioned on a front edge of a support surface 104 and are oriented to be identifiable (e.g., an item identifier such as a name, logo and/or slogan is observable by a customer and/or an item 106 is associated and aligned with a label 108 such as a SKU or a product code). For example, item 106-1 is positioned on a front edge of the support surface 104 and is oriented such that the item identifier is observable by a customer and the item 106-1 is associated and aligned with a corresponding label 108-1. In another example, item 106-2 is also positioned on the front edge of the support surface 104 and is oriented such that the item identifier “Colgate” is observable by a customer and the item 106-2 is associated and aligned with a corresponding label 108-2.

The system can automatically capture a reference image when a display module 102 is likely to be organized and/or re-stocked (e.g., when a display module 102 does not interface with customers). For example, the system can capture a reference image associated with a display module 102 present in a processed image before operating hours of a facility. In this way, the system can capture a reference image based on an optimal (e.g., an organized) state of a display module 102. The system can extract at least one attribute of a display module 102 present in a reference image by utilizing a neural network to convert the reference image into a set of floating vectors indicative of at least one attribute of the display module 102 present in the reference image. The system can store the reference image and/or the at least one extracted attribute of the display module 102 present in the reference image. The at least one extracted attribute can be at least one of a shape, a color, a pattern, a logo, a size, a width, a length, a height, and an item displayed by the display module 102 present in the reference image.

The system can update a reference image by capturing and storing a new reference image and/or at least one extracted attribute of a display module 102 present in the new reference image based on a predetermined time interval (e.g., daily, weekly, bi-weekly, monthly, etc.) set by a user. The time interval can be associated with one or more changes to a display module 102 including, but not limited to, a planogram, a season (e.g., Spring and Summer), a sale (e.g., President's Day and Memorial Day), a holiday (e.g., Fourth of July and Thanksgiving), an event (e.g., Halloween and back to school), a facility, and an item category and/or type, and an item shortage. The system can also receive a captured reference image from an associate (e.g., a user).

As mentioned above, the memory 134 can store a repository 138 including one or more image datasets of a plurality of reference images of display modules 102 and/or extracted attributes (e.g., a shape, color, pattern, logo, size, width, length, height, and items 106) thereof. Additionally or alternatively, the memory 204 of the device 116 can store one or more image datasets of a plurality of reference images of display modules 102 and/or extracted attributes (e.g., a shape, color, pattern, logo, size, width, length, height, and items 106) thereof. As described in further detail below, the system can determine at least one anomaly associated with a display module 102 based on a processed image and a reference image.

FIG. 3B is a flowchart 310 illustrating processing steps carried out by an embodiment of the present disclosure for quantifying a state of an object present in a processed image. Beginning in step 312, the system captures an image of an object (e.g., a display module 102). For example, the system can capture an image via the camera 210 of the device 116 by manipulating the camera 210 such that a FOV of the camera 210 includes at least a portion of the display module 102 including at least one item 106 and at least one label 108.

In step 314, the system processes the captured image. FIG. 4 is a flowchart illustrating step 314 of FIG. 3B in greater detail and FIGS. 5 and 6 are diagrams respectively illustrating image processing. The processing steps of FIG. 4 can be utilized to process a captured image (e.g., a reference image and/or a general image). Referring to FIG. 4, in step 332 the system determines whether a number of captured images is greater than 1. If the system determines that a number of captured images is greater than 1, then the process proceeds to step 334. In step 334, the system stitches the captured images together. Then, in step 338, the system generates a processed image 338 (e.g., a composite image). Generally, a facility employing frictionless checkout can utilize several overhead devices 116 (e.g., cameras) and these devices 116 can capture images of at least a portion of a display module 102 from different angles. As such, these images are stitched together to generate a processed image (e.g., a composite image) of a display module 102. FIG. 5 is a diagram 360 illustrating step 334 of FIG. 4 for image stitching. As shown in FIG. 5, images 362a, 362b and 362c illustrate a display module 102 carrying and displaying items 106-1 and 106-2 and are stitched together to generate a processed image 364 of the display module 102 and items 106-1 and 106-2 carried and displayed thereon.

Returning to FIG. 4, if the system determines that a number of captured images is not greater than 1, then the process proceeds to step 336. In step 336, the system rectifies the captured image to reduce image distortion. Then, in step 338, the system generates a processed image 338 (e.g., a rectified image). A facility can employ a device 116 (e.g., a smart phone, a tablet, a mobile computer, or a wearable) and this device 116 can capture an image of at least a portion of a display module 102 from a wide angle resulting in image distortion. Additionally or alternatively, a facility can employ a device 116 (e.g., a camera) mounted on a display module 102 and this device 116 can capture an image of at least a portion of another display module 102 positioned across therefrom from a wide angle resulting in image distortion. As such, this image is rectified to reduce image distortion and to generate a processed (e.g., rectified) image of a display module 102. FIG. 6 is a diagram 380 illustrating step 336 of FIG. 4 for image rectification. As shown in FIG. 6, image 382 of a display module 102 carrying and displaying items 106-1, 106-2, and 106-3 is rectified to generate a processed image 384 of the display module 102 and items 106-1, 106-2, and 106-3 carried and displayed thereon.

Returning to FIG. 3B, in step 316 the system extracts at least one attribute of the object (e.g., a display module 102) present in the processed image. For example, the system can extract at least one attribute of a display module 102 including, but not limited to, a shape, color, pattern, logo, size, width, length, height, and item 106 of the display module 102 by utilizing a neural network (e.g., a convolutional neural network (CNN)) to convert the processed image into a set of floating numbers or vectors indicative of at least one attribute of the display module 102. In this way the system can extract at least one global attribute of the display module 102. Alternatively, the system can extract a plurality of regional attributes of the display module 102 by applying matrices over different portions of the processed image. FIG. 7B is a diagram 420 illustrating step 316 of FIG. 3B. As shown in FIG. 7B, the system utilizes an attribute extractor 404 (e.g., a CNN) to covert the processed image 422 into a set of floating number or vectors indicative of at least one attribute of the display module 102 present in the processed image 422.

Returning to FIG. 3B, in step 318 the system determines at least one anomaly associated with the object (e.g., a display module 102) based on the processed image and the reference image by comparing at least one extracted attribute of the object present in the processed image and at least one extracted attribute of the object present in the reference image. For example, the system determines at least one anomaly based on a distance between the vectors of the processed and reference images via Equation 1 as follows:

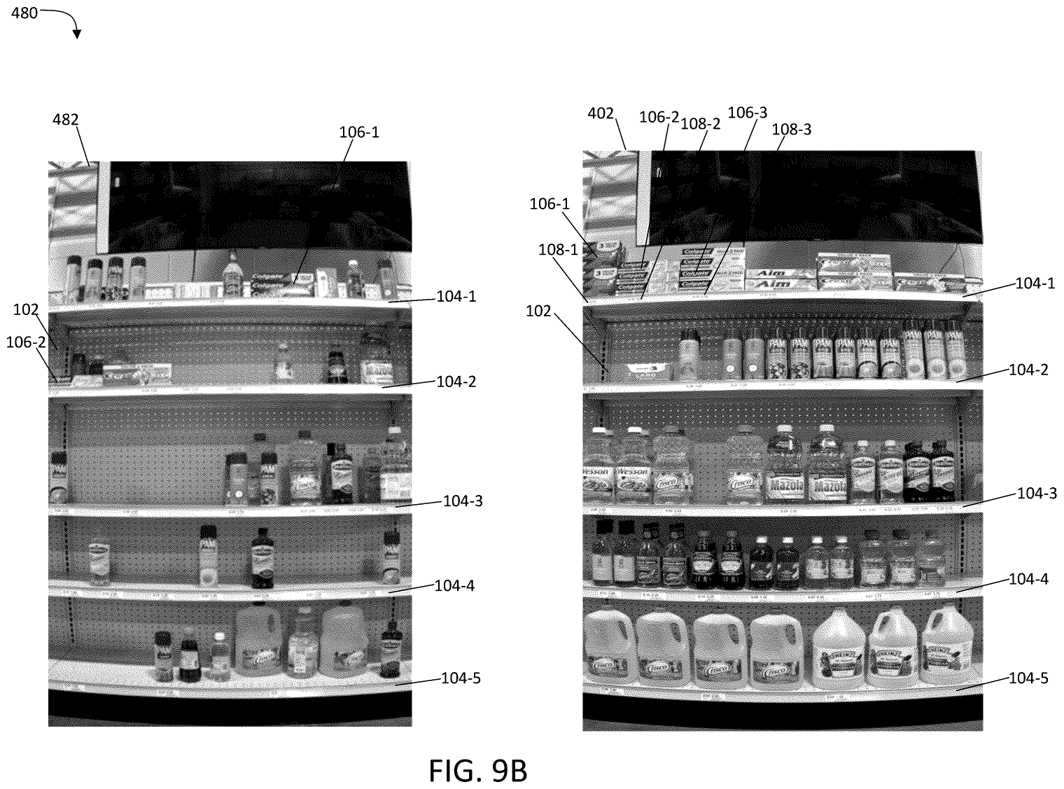

Anomaly=distance (processed image vector, reference vector) Equation 1

where each vector is indicative of at least one attribute of the display module 102 and the distance between each vector is a quantified value indicative of a state (e.g., unorganized) of a display module 102 present in a processed image. In this way, the system quantifies a state of the display module 102. For example, the system quantifies a state of a display module 102 present in a processed image by determining at least one anomaly associated with the display module 102 present in the processed image based on a comparison of at least one extracted attribute of the display module 102 present in the processed image and at least one extracted attribute of the display module 102 present in the reference image. The determined anomaly can encode (e.g., be indicative of) at least one deficiency associated with the display module 102 present in the processed image including, but not limited to, an item 106 that is out of stock, an item 106 positioned behind a front edge of a support surface 104, an item 106 oriented such that an identifier thereof is not observable by a customer, an item 106 misaligned with a label 108, and/or an item 106 associated with an incorrect label 108. FIGS. 9A-B are diagrams illustrating a comparison of a processed image and a reference image for determining an anomaly carried out by an embodiment of the present disclosure.

FIG. 9A is a diagram 460 illustrating a comparison of a display module 102 present in a processed image 422 and a display 102 present in a reference image 402 (as shown in FIGS. 7A and 8). As shown in FIG. 9A, the reference image 402 depicts an organized display module 102 where items 106 are faced on the display module 102 such that the items 106 are positioned on a front edge of a support surface 104 and are oriented to be identifiable (e.g., an item identifier such as a name, logo and/or slogan is observable by a customer and/or an item 106 is associated and aligned with a corresponding label 108 such as a SKU or a product code). For example, item 106-1 is positioned on a front edge of the support surface 104 and is oriented such that the item identifier is observable by a customer and the item 106-1 is associated and aligned with a corresponding label 108-1. In another example, item 106-2 is also positioned on the front edge of the support surface 104 and is oriented such that the item identifier “Colgate” is observable by a customer and the item 106-2 is associated and aligned with a corresponding label 108-2. Additionally, the items 106 positioned on the support surface 104-2 of the display module 102 in the reference image 402 are positioned on a front edge of the support surface 104-2. In another example, the items 106 positioned on the support surface 104-3 of the display module 102 in the reference image 402 are oriented such that respective item identifiers thereof are observable by a customer.

In contrast, the processed image 422 depicts an unorganized display module 102 associated with the display module 102 of the reference image 402 where items 106 are out of stock, positioned behind a front edge of respective support surfaces 104, oriented such that respective identifiers thereof are not observable by a customer, misaligned with corresponding labels 108, and/or associated with incorrect labels 108. For example, item 106-1 is positioned on an incorrect support surface 104-5 and, as such, is not associated and aligned with the corresponding label 108-1. In another example, item 106-2 is positioned on an incorrect support surface 104-4 and, as such, is not associated and aligned with the corresponding label 108-2. Additionally, the items 106 are not positioned on a front edge of the support surface 104-2 of the display module 102 in the processed image 422. In another example, the items 106 positioned on the support surface 104-3 of the display module 102 present in the processed image 422 are not oriented such that respective item identifiers thereof are observable by a customer. These examples are not exhaustive as several additional deficiencies associated with the display module 102 present in the processed image 422 are evident based on a comparison with the associated display module 102 present in the reference image 402.

It should be understood that the system can identify an anomaly (e.g., per item space) and can leverage additional processing techniques (e.g., algorithms) to determine anomaly types. For example and as described below, the system can also execute and transmit a more detailed analysis of the display module 102 to notify an associate of at least one deficiency associated with the display module 102.

FIG. 9B is a diagram 480 illustrating a comparison of a display module 102 present in a processed image 482 and a display module 102 present in a reference image 402 (as shown in FIGS. 7A and 8). As shown in FIG. 9B and mentioned above, the reference image 402 depicts an organized display module 102 where items 106 are faced on the display module 102 such that the items 106 are positioned on a front edge of a support surface 104 and are oriented to be identifiable (e.g., an item identifier such as a name, logo and/or slogan is observable by a customer and/or an item 106 is associated and aligned with a corresponding label 108 such as a SKU or a product code). For example, item 106-1 is positioned on a front edge of the support surface 104 and is oriented such that the item identifier is observable by a customer and the item 106-1 is associated and aligned with a corresponding label 108-1. In another example, item 106-2 is also positioned on the front edge of the support surface 104 and is oriented such that the item identifier “Colgate” is observable by a customer and the item 106-2 is associated and aligned with a corresponding label 108-2. Additionally, the items 106 positioned on the support surface 104-2 of the display module 102 in the reference image 402 are positioned on a front edge of the support surface 104-2. In another example, the items 106 positioned on the support surface 104-3 of the display module 102 in the reference image 402 are oriented such that respective item identifiers thereof are observable by a customer.

In contrast, the processed image 482 depicts an unorganized display module 102 associated with the display module 102 of the reference image 402 where items 106 are out of stock, positioned behind a front edge of respective support surfaces 104, oriented such that respective identifiers thereof are not observable by a customer, misaligned with corresponding labels 108, and/or associated with incorrect labels 108. For example, item 106-1 is not aligned with the corresponding label 108-1. In another example, item 106-2 is positioned on an incorrect support surface 104-2 and, as such, is not associated and aligned with the corresponding label 108-2. Additionally, the items 106 positioned on the support surface 104-2 of the display module 102 present in the reference image 402 are dispersed among several support surfaces 104-1, 104-3, 104-4, and 104-5 of the display module 102 present in the processed image 482. These examples are not exhaustive as several additional deficiencies associated with the display module 102 present in the processed image 422 are evident based on a comparison with the associated display module 102 present in the reference image 402.

Returning to FIG. 3B, in step 320 the system determines whether an anomaly is greater than a threshold. The system can set a threshold based on at least one variable that can impact a state of a display module 102 including, but not limited to, a change in season (e.g., Spring and Summer), a sale (e.g., President's Day and Memorial Day), a holiday (e.g., Fourth of July and Thanksgiving), an event (e.g., Halloween and back to school), a facility, an item category, an item type and/or any combination thereof. For example, extra inventory (e.g., items 106) may be positioned on a display module 102 during a back to school event such that the display module 102 may not accommodate all of the items 106 according to a planogram. In another example, by interfacing with increased customer traffic during a sale, a display module 102 can become unorganized and/or depleted more quickly. In this way, the system allows for flexibility when quantifying a state (e.g., unorganized) of a display module 102.

If the system determines that the anomaly is greater than the threshold, then the process proceeds to step 322. In step 322, the system generates and transmits a notification to alert an associate (e.g., a user) of the anomaly and/or to prompt the associate re-organize the display module 102. The system can also execute and transmit a more detailed analysis of the display module 102 to notify an associate of at least one deficiency associated with the display module 102. In this way, the system can automatically notify an associate in real-time of an unorganized and/or depleted state of a display module 102. This can reduce lost sales and facility liability due to an onsite injury because an associate can re-organize the display module 102 such that customers can locate items of interest and items do not fall from the display module 102. If the system determines that the anomaly is not greater than the threshold, then the process ends.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed:

1. A method, comprising:
capturing at least one image of at least a portion of an object, the object being a display module for displaying at least one item;
processing the at least one captured image;
extracting at least one attribute of the object present in the processed image;
obtaining at least one extracted attribute of the object present in a reference image, the reference image being indicative of an optimal state of the object present in the processed image;
quantifying a state of the object present in the processed image by determining at least one anomaly associated with the object present in the processed image based on a comparison of the at least one extracted attribute of the object present in the processed image and the at least one extracted attribute of the object present in the reference image;
determining whether the at least one anomaly is greater than a threshold; and
generating and transmitting a notification when the at least one anomaly is greater than the threshold,
wherein the at least one anomaly is indicative of at least one deficiency associated with the object present in the processed image.

2. The method of claim 1, wherein processing the at least one captured image comprises:
determining whether a number of captured images is greater than one;
in response to determining the number of captured images is greater than one, stitching the captured images together to generate the processed image; and
in response to determining the number of captured images is not greater than one, rectifying the captured image to generate the processed image.

3. The method of claim 1, wherein extracting the at least one attribute of the object present in the processed image comprises:
utilizing a neural network to convert the processed image into a set of floating vectors indicative of at least one global attribute of the object present in the processed image, the at least one global attribute being at least one of a shape, a color, a pattern, a logo, a size, a width, a length, a height, and an item displayed by the object present in the processed image.

4. The method of claim 1, wherein extracting the at least one attribute of the object present in the processed image comprises:
applying matrices over different portions of the processed image; and
utilizing a neural network to convert the processed image into sets of floating vectors respectively indicative of regional attributes corresponding to the different portions of the object in the processed image, each regional attribute being at least one of a shape, a color, a pattern, a logo, a size, a width, a length, a height, and an item displayed by the object in the processed image.

5. The method of claim 1, further comprising:
capturing the reference image;
extracting the at least one attribute of the object present in the reference image by utilizing a neural network to convert the reference image into a set of floating vectors indicative of at least one global attribute of the object present in the reference image; and
storing the at least one extracted global attribute of the object present in the reference image, wherein
the global attribute is at least one of a shape, a color, a pattern, a logo, a size, a width, a length, a height, and an item displayed by the object present in the reference image.

6. The method of claim 5, further comprising:
updating the reference image based on a predetermined time interval.

7. The method of claim 1, wherein
the object comprises at least one support surface, the at least one support surface being at least one of a shelf, a rack, a bay, and a bin for displaying the at least one item, and
the at least one deficiency associated with the object in the processed image is at least one of an item being out of stock, an item positioned behind a front edge of the support surface of the object, an item oriented such that an identifier thereof is not observable, an item misaligned with a label of the support surface of the object, and an item associated with an incorrect label of the support surface of the object.

8. A device, comprising:
an imaging assembly configured to capture at least one image of at least a portion of an object, the object being a display module for displaying at least one item;
one or more processors; and
a non-transitory computer-readable memory coupled to the imaging assembly and the one or more processors, the memory storing instructions thereon that, when executed by the one or more processors, cause the one or more processors to:
process the at least one captured image;
extract at least one attribute of the object present in the processed image;
obtain at least one extracted attribute of the object present in a reference image, the reference image being indicative of an optimal state of the object present in the processed image;
quantify a state of the object present in the processed image by determining at least one anomaly associated with the object present in the processed image based on a comparison of the at least one extracted attribute of the object present in the processed image and the at least one extracted attribute of the object present in the reference image;
determine whether the at least one anomaly is greater than a threshold; and
generate and transmit a notification when the at least one anomaly is greater than the threshold,
wherein the at least one anomaly is indicative of at least one deficiency associated with the object present in the processed image.

9. The device of claim 8, wherein the instructions, when executed, cause the one or more processors to process the at least one captured image by:
determining whether a number of captured images is greater than one;
in response to determining the number of captured images is greater than one, stitching the captured images together to generate the processed image; and
in response to determining the number of captured images is not greater than one, rectifying the captured image to generate the processed image.

10. The device of claim 8, wherein the instructions, when executed, cause the one or more processors to extract the at least one attribute of the object present in the processed image by:
utilizing a neural network to convert the processed image into a set of floating vectors indicative of at least one global attribute of the object present in the processed image, the at least one global attribute being at least one of a shape, a color, a pattern, a logo, a size, a width, a length, a height, and an item displayed by the object present in the processed image.

11. The device of claim 8, wherein the instructions, when executed, cause the one or more processors to extract the at least one attribute of the object present in the processed image by:
applying matrices over different portions of the processed image; and
utilizing a neural network to convert the processed image into sets of floating vectors respectively indicative of regional attributes corresponding to the different portions of the object in the processed image, each regional attribute being at least one of a shape, a color, a pattern, a logo, a size, a width, a length, a height, and an item displayed by the object in the processed image.

12. The device of claim 8, wherein the instructions, when executed, further cause the one or more processors to:
capture the reference image;
extract the at least one attribute of the object present in the reference image by utilizing a neural network to convert the reference image into a set of floating vectors indicative of at least one global attribute of the object present in the reference image; and
store the at least one extracted global attribute of the object present in the reference image, wherein
the global attribute is at least one of a shape, a color, a pattern, a logo, a size, a width, a length, a height, and an item displayed by the object present in the reference image.

13. The device of claim 8, wherein
the device is one of a phone, a tablet, a mobile computer, a wearable, and a camera;
the object comprises at least one support surface, the at least one support surface being at least one of a shelf, a rack, a bay, and a bin for displaying the at least one item, and
the at least one deficiency associated with the object in the processed image is at least one of an item being out of stock, an item positioned behind a front edge of the support surface of the object, an item oriented such that an identifier thereof is not observable, an item misaligned with a label of the support surface of the object, and an item associated with an incorrect label of the support surface of the object.

14. A system, comprising:
at least one device having an imaging assembly configured to capture at least one image of at least a portion of an object, the object being a display module for displaying at least one item;
a server having one or more processors; and
a non-transitory computer-readable memory coupled to the server and the one or more processors, the memory storing instructions thereon that, when executed by the one or more processors, cause the one or more processors to:
process the at least one captured image;
extract at least one attribute of the object present in the processed image;
obtain at least one extracted attribute of the object present in a reference image, the reference image being indicative of an optimal state of the object present in the processed image;
quantify a state of the object present in the processed image by determining at least one anomaly associated with the object present in the processed image based on a comparison of the at least one extracted attribute of the object present in the processed image and the at least one extracted attribute of the object present in the reference image;
determine whether the at least one anomaly is greater than a threshold; and
generate and transmit a notification when the at least one anomaly is greater than the threshold,
wherein the at least one anomaly is indicative of at least one deficiency associated with the object present in the processed image.

15. The system of claim 14, wherein the instructions, when executed, cause the one or more processors to process the at least one captured image by:
determining whether a number of captured images is greater than one;
in response to determining the number of captured images is greater than one, stitching the captured images together to generate the processed image; and
in response to determining the number of captured images is not greater than one, rectifying the captured image to generate the processed image.

16. The system of claim 14, wherein the instructions, when executed, cause the one or more processors to extract the at least one attribute of the object present in the processed image by:
utilizing a neural network to convert the processed image into a set of floating vectors indicative of at least one global attribute of the object present in the processed image, the at least one global attribute being at least one of a shape, a color, a pattern, a logo, a size, a width, a length, a height, and an item displayed by the object present in the processed image.

17. The system of claim 14, wherein the instructions, when executed, cause the one or more processors to extract the at least one attribute of the object present in the processed image by:
applying matrices over different portions of the processed image; and
utilizing a neural network to convert the processed image into sets of floating vectors respectively indicative of regional attributes corresponding to the different portions of the object in the processed image, each regional attribute being at least one of a shape, a color, a pattern, a logo, a size, a width, a length, a height, and an item displayed by the object in the processed image.

18. The system of claim 14, wherein the instructions, when executed, further cause the one or more processors to:
capture the reference image;
extract the at least one attribute of the object present in the reference image by utilizing a neural network to convert the reference image into a set of floating vectors indicative of at least one global attribute of the object present in the reference image; and
store the at least one extracted global attribute of the object present in the reference image, wherein
the global attribute is at least one of a shape, a color, a pattern, a logo, a size, a width, a length, a height, and an item displayed by the object present in the reference image.

19. The system of claim 14, wherein
the at least one device is one of a phone, a tablet, a mobile computer, a wearable, and a camera;
the object comprises at least one support surface, the at least one support surface being at least one of a shelf, a rack, a bay, and a bin for displaying the at least one item, and
the at least one deficiency associated with the object in the processed image is at least one of an item being out of stock, an item positioned behind a front edge of the support surface of the object, an item oriented such that an identifier thereof is not observable, an item misaligned with a label of the support surface of the object, and an item associated with an incorrect label of the support surface of the object.

20. A method, comprising
receiving at least one captured image of at least a portion of an object, the object being a display module for displaying at least one item;
quantifying a state of the object present in the at least one captured image by determining at least one anomaly associated with the object present in the at least one captured image based on a comparison of at least one extracted attribute of the object present in the at least one captured image and at least one extracted attribute of the object present in a reference image, the reference image being indicative of an optimal state of the object present in the at least one captured image;
determining whether the at least one anomaly is greater than a threshold; and
generating and transmitting a notification when the at least one anomaly is greater than the threshold,
wherein the at least one anomaly is indicative of at least one deficiency associated with the object present in the at least one captured image.
